(19) United States
(12) Patent Application Publication
(10) Pub. No.: US 2025/0376098 A1
(43) Pub. Date: Dec. 11, 2025

(54) VEHICLE SEAT COMPONENT

(71) Applicant: Faurecia Autositze GmbH, Hannover (DE)

(72) Inventors: Piotr Ceglarek, Katowice (PL); Tomasz Stasinski, Dzierzoniow (PL); Thierry Blaise, Etampes Cedex (FR); Thomas Dagonet, Versailles (FR)

(73) Assignee: Faurecia Autositze GmbH, Hannover (DE)

(21) Appl. No.: 19/225,128

(22) Filed: Jun. 2, 2025

(30) Foreign Application Priority Data
Jun. 6, 2024 (DE) 102024115857.3

(51) Int. Cl. B60N 2/90; A61H 9/00; B60N 2/58

(52) U.S. Cl. CPC B60N 2/976; A61H 9/0078; B60N 2/58; A61H 2201/0149; A61H 2203/0431

(57) ABSTRACT

A vehicle seat component having a front side, a rear side, a seat cover, a carrier component, a padding arranged between the carrier component and the seat cover, a first padding element having at least one recess or through-opening, at least one or a plurality of fluid-fillable bladders belonging to a seat massage system, which bladders are accommodated directly or indirectly in the at least one recess or through-opening or a plurality of recesses or through-openings of the first padding element, wherein the vehicle seat component has a second padding element, wherein, on its/their side facing the carrier component, the bladder(s) is/are arranged, preferably directly, on the second padding element or on a carrier element arranged between the first padding element and the second padding element.

### CROSS REFERENCE TO RELATED APPLICATIONS

This application claims priority on and the benefit of German Patent Application No. DE 10 2024 115 857.3 having a filing date of 6 Jun. 2024.

### BACKGROUND OF THE INVENTION

### Technical Field

The invention relates to a vehicle seat component.

### PRIOR ART

Corresponding vehicle seat components 1, as shown for example in the sectional views of FIGS. 1 and 2, have a front side A, also referred to as A-side, and a rear side B, also referred to as B-side. Vehicle seats are often equipped with a seat massage system. Said seat massage system typically comprises a plurality of fluid-fillable bladders 51, 52, which are filled and/or emptied according to a predetermined pattern in order to carry out a corresponding massage program. Said bladders 51, 52 are usually arranged in a space 70, 71, 72 provided for this purpose in the padding 3 or above the padding 3. Vehicle seat components 1 equipped with such massage systems generally have a seat cover 6 on one side and a carrier component 2 on the other side and a padding 3 in between. The padding 3 is usually formed from a foam material.

Due to this composition, there are two different ways of arranging the corresponding bladders 51, 52 of the seat massage system. One way is to arrange them on the rear side and the other way is to arrange corresponding bladders on the front side (beneath the seat cover) (FIG. 1). The B-side variant (FIG. 2) is the more cost-effective variant, but it has the disadvantage that the person sitting in the seat will not perceive the massage as being intense, especially since the pressure forces exerted by the fluid-fillable bladders 51, 52 are transmitted via the foam of the padding. This creates a weakening effect. Arranging the bladders on the A-side, i.e., below the seat cover 6, as shown in FIG. 1, is more expensive, but more effective in the manner described. In order to increase the pressure force of the fluid-fillable bladders 51, 52, they are usually supported on a rigid body 4, for example on a plastics material plate or the like, on the side facing the B-side.

Accordingly, there is a need for a solution for a vehicle seat component that can achieve similar effects as when arranging the fluid-fillable bladders between the padding and the seat cover, but at reduced costs.

The object of the invention is therefore to provide a vehicle seat component which meets these requirements.

### BRIEF SUMMARY OF THE INVENTION

This object is achieved by a vehicle seat component having a front side and a rear side, the vehicle seat comprising a seat cover, a carrier component, a padding arranged between the carrier component and the seat cover and comprising a first padding element having at least one recess or through-opening, at least one or a plurality of fluid-fillable bladders belonging to a seat massage system, which bladders are accommodated directly or indirectly in the at least one recess or through-opening or a plurality of recesses or through-openings of the first padding element, wherein the vehicle seat component has a second padding element, wherein, on its/their side facing the carrier component, the bladder(s) is/are arranged, preferably directly, on the second padding element or on a carrier element arranged between the first padding element and the second padding element. Advantageous embodiments can be found in the dependent claims.

With the help of the present invention, the object according to the invention is achieved by relocating the massage bladders “almost” to the A-side. This is achieved primarily by dividing the padding into a plurality of padding elements, thus allowing greater flexibility in the arrangement of the fluid-fillable bladders. In this way, the massage bladders can be placed closer to the seat cover, which results in a much more intense massage experience than a pure B-side massage, almost equivalent to that of the much more expensive A-side massage.

A vehicle seat component according to the invention having a front side and a rear side comprises a seat cover, a carrier component and a padding. Said padding is arranged between the carrier component and the seat cover and comprises a first padding element which has at least one recess or through-opening. The vehicle seat component further has at least one or a plurality of fluid-fillable bladders belonging to a seat massage system, which are directly or indirectly accommodated in the at least one recess or through-opening or a plurality of recesses or through-openings of the first padding element.

According to the invention, the vehicle seat component has a second padding element. On its/their side facing the carrier component, the bladder(s) is/are arranged, preferably directly, on the second padding element or on a carrier element arranged between the first padding element and the second padding element.

In a preferred embodiment, the second padding element is arranged in a recess or through-opening of the first padding element. The second padding element itself comprises at least one further recess or through-opening in which one or a plurality of fluid-fillable bladders is arranged. In this way, a fluid-fillable bladder can be arranged in the second padding element, namely directly adjacent to the seat cover. This is an example of the above-mentioned indirect accommodation of fluid-fillable bladders in the recess or through-opening of the first padding element.

According to a further embodiment of the present invention, it is provided for the carrier component to have a plastic material as an essential material component or to be made of plastic. For example, a module carrier can be used which consists of a prefabricated piece of plastic, for example in the form of a plastic shell, or is at least substantially formed therefrom. This allows for a particularly component-friendly design, as many parts of the required components can already be integrated in the plastic carrier.

The carrier element can be formed from different materials. Typically, it should be at least somewhat stiffer than the material of the fluid-fillable bladder so that when the fluid-fillable bladder is filled, its underside can rest on said carrier element. One possibility is that the carrier element is a film carrier. Of course, other embodiments are also possible.

According to a further preferred embodiment of the present invention, the second padding element is arranged on or rests on the carrier component. Of course, at least one further component can also be arranged between the second padding element and the carrier component.

The connection between the first padding element and the second padding element can basically be made in different ways. It is also possible that at least one further component is arranged between the two padding elements. However, according to a preferred embodiment, it is provided for the second padding element to be accommodated in the first padding element in a positive-locking manner.

According to a preferred embodiment of the vehicle seat component according to the invention, it is provided for the first and/or the second padding element to be formed from a foam material. Of course, other materials are also conceivable. Particularly, the first and/or second padding element can also be formed from another elastic material. For this purpose, a material is preferably provided which is formed from a 3-D structure comprising thermoplastic elastomeric fibers, for example elastomeric filaments formed therefrom. This can be a 3D interweaving of randomly arranged thermoplastic continuous fibers that form loops and are preferably welded together. For example, polyester-based elastomeric fibers can be used. Furthermore, the elastomeric fibers can be designed with different cross sections and/or as hollow or solid fibers. The aforementioned 3D structure can, for example, also be formed by elastomeric filaments arranged randomly or according to a predetermined pattern. It is also conceivable for a certain compressibility to exist and preferably for the compressibility or the compressive hardness of the two padding elements to be different from each other. This can be achieved by choosing different materials or, if the material is identical, by using different thicknesses of the two materials.

According to a preferred embodiment, it can be provided for the padding to have a total thickness from the rear side to the front side, wherein the thickness of the first padding element in the region of the bladder(s) is between 60 and 100%, preferably about 75%, based on the total thickness, and/or the thickness of the second padding element is between 0 and 40%, preferably about 25%, based on the total thickness. Of course, there can also be other ratios of the selected thickness. For example, the second padding element in the region of the bladder(s) can also be thicker than the first padding element in relation to the total thickness.

It can also preferably be provided for a plurality of fluid-fillable bladders to be arranged in a single recess or through-opening. From a production point of view, the padding material is somewhat easier to manufacture, since only a single recess or through-opening needs to be provided.

The arrangement of the recess(es) or through-opening(s) can also be selected depending on the desired compression hardness or desired geometry. For example, it can be provided for the recess(es) or through-opening(s) in the first padding element to extend close to the seat cover or to be open toward the seat cover. In this way, for massage purposes, the pressure point of each fluid-fillable bladder can be moved as close as possible to the body of the person sitting in the seat. Ideally, the pressure point is directly below the seat cover.

The vehicle seat component according to the invention can further be designed such that the second padding material does not extend over the entire carrier component, but only over a region in which one or a plurality of fluid-fillable bladders is arranged. For example, the material selection of the second padding material can be such that a certain pressure stiffness is given in the padding in those regions where the fluid-fillable bladders are located, while the padding as a whole is designed to be comfortable for the person sitting in the seat in the other regions where no fluid-fillable bladders are arranged. In other words, the possibly stiffer regions that are required for applying pressure when executing the massage program can be limited to those regions where fluid-fillable bladders are actually located.

The invention also relates to a method for producing a vehicle seat component, preferably a vehicle seat component as described above. The method comprises the steps of:
a) providing a first seat component part having a seat cover and a first padding element arranged thereunder;
b) providing a second seat component part having a carrier component and a second padding element arranged thereon; and
c) assembling the first seat component part and the second seat component part.

In this way, the individual seat components can be delivered as prefabricated components. The fluid-fillable bladder(s) mentioned above can be pre-equipped, but can also be inserted during the joining process. According to a preferred embodiment, there are several alternatives, namely that one or a plurality of fluid-fillable bladders is arranged on the first and/or the second seat component part or is arranged before assembly or is inserted between the two seat component parts during assembly. In a preferred variant, the carrier component is attached to the seat structure, the second padding element arranged thereon and the fluid-fillable bladders arranged thereon. In the next step, the first seat component part is also attached to the seat structure. Said attachment can be carried out, for example, as a tool-free connection using tensioning elements such as straps or belts or elastic bands, which at the same time ensure that the seat cover is stretched over the padding.

In this way, the production of a motor vehicle seat or the vehicle seat component discussed in more detail herein is greatly simplified by connecting pre-configured seat component parts to one another.

### BRIEF DESCRIPTION OF THE DRAWINGS

The invention is explained in more detail below with reference to FIGS. 1-7, wherein FIGS. 3-7 illustrate exemplary embodiments according to the invention.

FIG. 1 shows a sectional view through part of a vehicle seat component according to the prior art.

FIG. 2 shows a sectional view through part of another vehicle seat component according to the prior art.

FIG. 3 shows a sectional view comparable to FIGS. 1 and 2 through a vehicle seat component according to the invention according to a first embodiment.

FIG. 4 shows a sectional view through a vehicle seat component according to the invention according to a second embodiment.

FIG. 5 shows a sectional view through a vehicle seat component according to the invention according to a third embodiment.

FIG. 6 shows a sectional view through a vehicle seat component according to the invention according to a fourth embodiment.

FIG. 7 shows a sectional view through a vehicle seat component according to the invention according to a fifth embodiment.

FIG. 8 shows a sectional view through a vehicle seat component according to the invention according to a sixth embodiment.

### DETAILED DESCRIPTION OF PREFERRED EMBODIMENTS

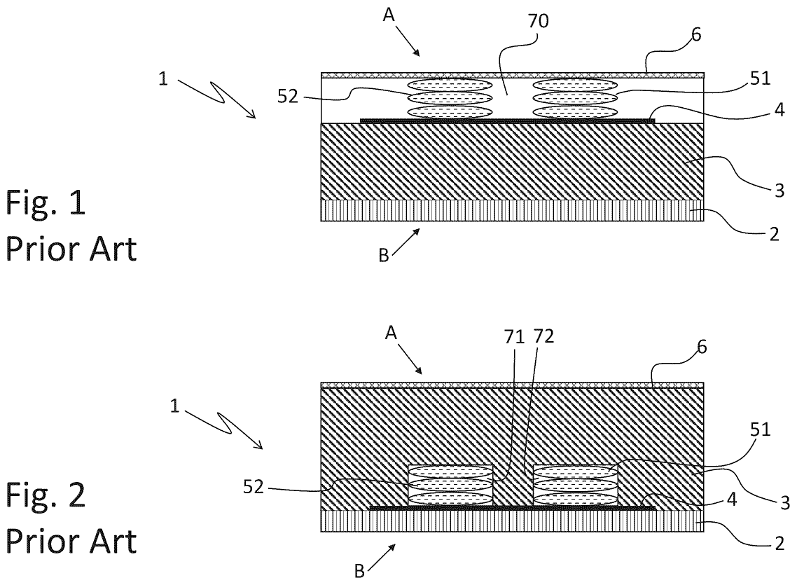

FIGS. 1 and 2 have already been discussed above, so to avoid repetition, reference is made to the above explanations. The reference signs used in FIGS. 1 and 2 are also used in the discussion of the exemplary embodiments according to the invention, so that for an explanation of the components associated with said reference sign, reference can also be made to the above embodiments.

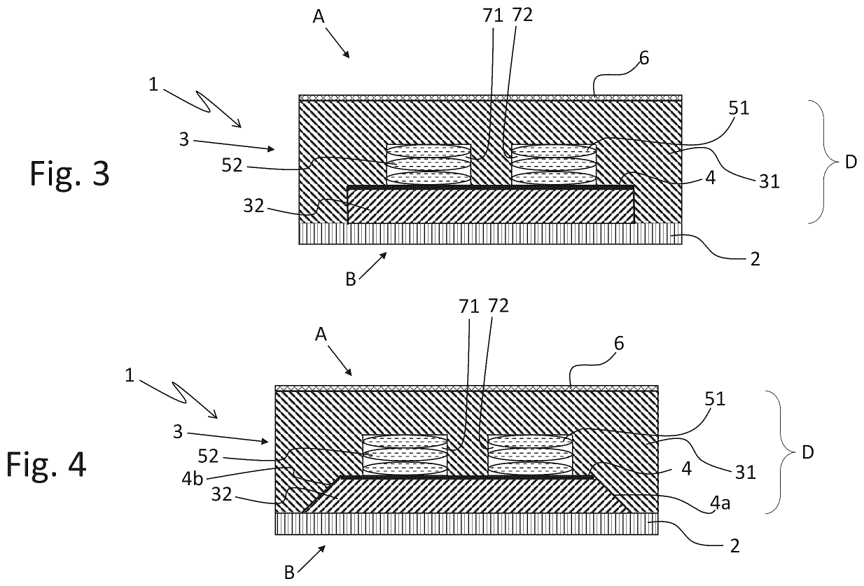

FIG. 3 shows the sectional view of a vehicle seat component 1 according to the invention with front side A and rear side B. The front side A faces a potential user and covers the remaining elements of the vehicle seat component 1 with a seat cover 6. The seat cover 6 rests on a first padding element 31. In the region in which no bladders 51, 52 are arranged, the first padding element 31 extends to the carrier component 2, which forms the rear side B and supports the vehicle seat component 1.

In the regions of the padding 3 in which the bladders 51, 52 are to be arranged and slightly beyond that, a recess is arranged toward the rear side which is later filled with a second padding element 32. The depth of said recess is preferably between 10 and 40% of the total thickness D of the padding 3. The depth is preferably 25% of the total thickness D. Starting from said recess, in this embodiment, cylindrical recesses 71, 72 for accommodating the bladders 51, 52 are introduced into the first padding element 31 in the direction of the front side A. If the bladders 51, 52 are arranged in the recesses 71, 72, the recesses 71, 72 are closed over a large area with carrier elements 4, wherein the carrier elements 4 can certainly carry the associated fluid infrastructure such as supply and discharge lines, valves and even fluid pumps. The recess is furthermore filled with the second padding element 32, which is inserted in an accurately fitting manner into the recess.

The padding 3 is preferably, but not necessarily, made of foam. The two padding elements 31, 32 can be made of the same material; however, the second padding element 32 is preferably somewhat harder or denser than the first padding element 31 so as to better support the carrier element 4 and thus the bladders 51, 52, whereby the expanding bladders 51, 52 direct the pressure preferably toward the front side A, as desired.

A carrier element 4 is not absolutely necessary, and this generally applies to all embodiments. The bladders 51, 52 can just as well be supported directly on the second padding element 32.

This embodiment of the vehicle seat component 1 according to the invention basically corresponds to the solution known from the prior art and shown in FIG. 2. However, the bladders 51, 52 are arranged much closer toward the front side A, so that the effect of a changed filling of the bladders 51, 52 reaches the front side A more easily. Accordingly, the structure is cost-effective, wherein the transmission of the pulses triggered by filling or emptying the bladders 51, 52 easier and thus more easily reach the front side A of the seat.

The embodiment of a vehicle seat component 1 according to the invention shown in FIG. 4 substantially corresponds to the embodiment discussed in FIG. 3. Most elements correspond to the embodiment discussed in FIG. 3, so the description will not be repeated here. The embodiment shown here differs in that the side walls of the recess into which the second padding element 32 is inserted are not vertical, but instead are preferably at an angle. When the bladders 51, 52 are covered by the carrier element 4, the side walls are also covered with carrier elements 4a, 4b so that the lines can be led out of the padding 3 more easily and safely.

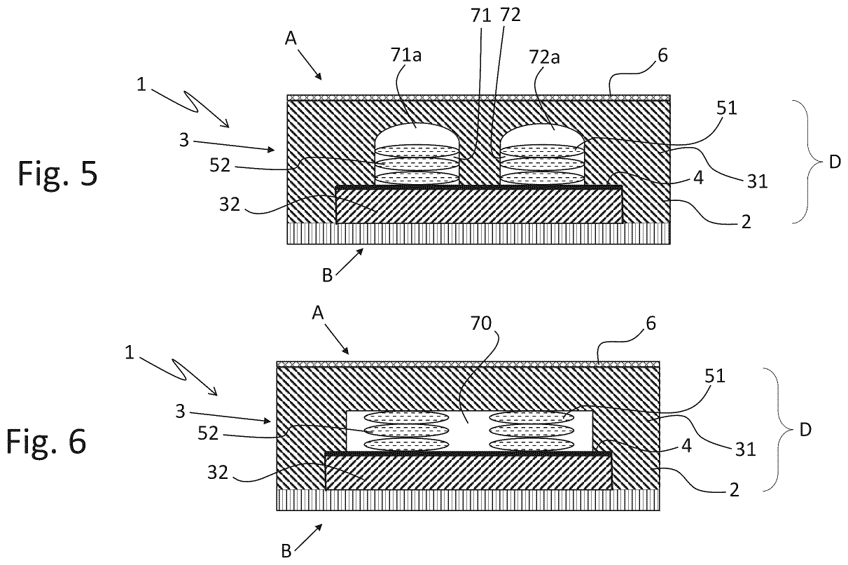

The third embodiment of a vehicle seat component 1 according to the invention shown in FIG. 5 is also similar to the embodiment described in FIG. 3. In this embodiment, the bottoms of the recesses 71, 72 accommodating the bladders 51, 52 are not flat like the embodiment shown in FIG. 3, but are curved 71A, 72a toward the front side A. As a result, the bladders 51, 52 move closer to the front side A, especially when they are filled. The pressure which is to be transferred to the front side by inflating the bladders 51, 52 is thereby transferred more precisely. A person sitting in the vehicle seat can thus more easily experience a change in the fluid pressure in the bladder 51, 52, so that the vehicle seat component 1 can work more effectively and thus comes closer to the performance of the variant shown in FIG. 1.

The fourth embodiment of a vehicle seat component 1 according to the invention shown in FIG. 6 is also similar to the embodiment described in FIG. 3. This embodiment differs from that discussed in relation to FIG. 3 in that there is not a correspondingly adapted recess 71, 72 for each bladder 51, 52, but rather a recess 70 is provided in the first padding element 31 which can accommodate a plurality of bladders 51, 52. On the one hand, the recess 70 can be large enough that it can accommodate all the bladders 51, 52 of the vehicle seat component 1, or a plurality of recesses 70 is provided in the padding 3, each recess accommodating more than one bladder 51, 52.

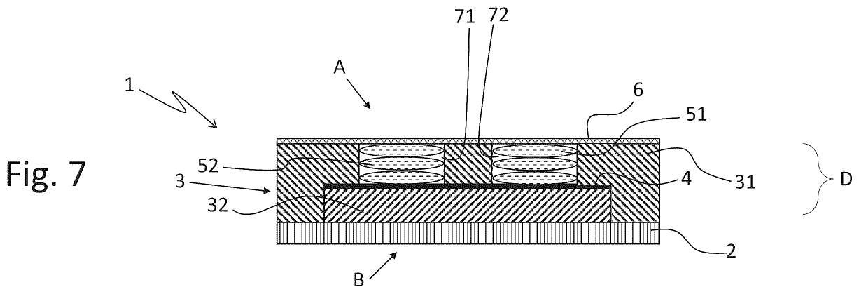

FIG. 7 shows a fifth embodiment of a vehicle seat component 1 according to the invention. The structure roughly corresponds to the previously described exemplary embodiments: The seat cover 6 on the front side A of the vehicle seat component 1 is arranged on the padding 3, consisting of the first padding element 31, which in turn is arranged on the carrier component 2 that forms the rear side B. In the regions in which the bladders 51, 52 are to be arranged, a recess is provided in the first padding element 31 from the rear side. On the bottom of this recess, the recesses 71, 72 for the bladders 51, 52 are provided in the first padding element 31. In this exemplary embodiment, the recesses extend to the front side of the first padding element 31, so that only the seat cover 6 is stretched between the bladders 51, 52 and the front side A of the seat. The recesses 71, 72 are closed by the carrier element 4 toward the rear side. The large recess toward the rear side B is closed in an accurately fitting manner with the second padding element 32. This embodiment comprises the cost-effective structure known from the version shown in FIG. 2, but at the same time is quite close to the technology shown in FIG. 1. Changes in the filling of the bladders 51, 52 are immediately transmitted through the cover material 6 to a person sitting in the seat, which makes the system appear fast and comfortable for the person.

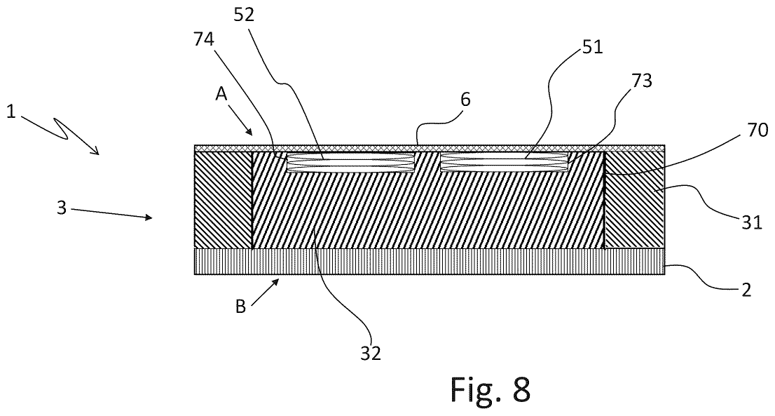

The variant of a vehicle seat component 1 according to the invention shown in FIG. 8 differs from the previous variants in that the fluid-fillable bladders 51, 52 are not located directly in a recess 70 of the first padding element 31, but are arranged indirectly therein. This is done by introducing at least one fluid-fillable bladder 51, 52 into at least one recess or through-opening 73, 74 of the second padding element 32. This recess 73, 74 can preferably be arranged near the A-side, i.e., immediately adjacent to the seat cover 6, so that the fluid-fillable bladder 51, 52 inserted into the second padding element 32 can then be arranged as close as possible to the front side A. Of course, it is possible to use a carrier element 4, as has been described in the previous embodiments, also in the embodiment shown.

With the vehicle seat component 1 according to the invention, it has been possible to create a cost-effective device which produces almost the same presentation of a massage effect for the user as a substantially more expensive solution known from the prior art. This means that the massage effect, which is basically expensive, can be offered cost-effectively in a motor vehicle seat.

What is claimed is:

1. A vehicle seat component (1) having a front side (A) and a rear side (B), comprising:
a seat cover (6);
a carrier component (2);
a padding (3) arranged between the carrier component (2) and the seat cover (6) and comprising a first padding element (31) having at least one recess or through-opening (70, 71, 72); and
at least one or a plurality of fluid-fillable bladders (51, 52) belonging to a seat massage system, which bladders are accommodated directly or indirectly in the at least one recess or through-opening or a plurality of recesses (70, 71, 72) or through-openings of the first padding element (31), wherein the vehicle seat component (1) has a second padding element (32), wherein, on its/their side facing the carrier component (2), the bladder(s) (51, 52) is/are arranged, preferably directly, on the second padding element (32) or on a carrier element (4) arranged between the first padding element (31) and the second padding element (32).

2. The vehicle seat component (1) according to claim 1, wherein the carrier component (2) has a plastic material as an essential material component or is made of plastic.

3. The vehicle seat component (1) according to claim 1, wherein the carrier element (4) is a film carrier.

4. The vehicle seat component (1) according to claim 1, wherein the second padding element (32) is arranged on or rests on the carrier component (2).

5. The vehicle seat component (1) according to claim 1, the second padding element (32) is accommodated in the first padding element (31) in a positive-locking manner.

6. The vehicle seat component (1) according to claim 1, wherein the padding (3) has a total thickness (D) from the rear side (B) to the front side (A), wherein the thickness of the first padding element (31) in the region of the bladder(s) (51, 52) is between 60 and 100%, preferably about 75%, based on the total thickness (D), and/or the thickness of the second padding element (32) is between 0 and 40%, preferably about 25%, based on the total thickness (D).

7. The vehicle seat component (1) according to claim 1, wherein the first and/or the second padding element (31, 32) is/are formed from a foam material or other elastically deformable material.

8. The vehicle seat component (1) according to claim 1, wherein a plurality of fluid-fillable bladders (51, 52) is arranged in a single recess (70) or through-opening.

9. The vehicle seat component (1) according to claim 1, wherein the recess(es) (70, 71, 72) or through-opening(s) in the first padding element (31) extend close to the seat cover (6) or are open toward the seat cover (6).

10. The vehicle seat component (1) according to claim 1, wherein the second padding material (32) does not extend over the entire carrier component (2), but only over a region in which one or a plurality of fluid-fillable bladders (51, 52) is arranged.

11. The vehicle seat component (1) according to claim 1, wherein the second padding element (32) is arranged in a recess or through-opening (70) of the first padding element (31) and itself comprises at least one further recess or through-opening (73, 74) in which one or a plurality of fluid-fillable bladders (51, 52) is arranged.

12. A method for producing a vehicle seat component (1), comprising the steps of:
a) providing a first seat component part having a seat cover (6) and a first padding element (31) arranged thereunder;
b) providing a second seat component part having a carrier component (2) and a second padding element (32) arranged thereon; and
c) assembling the first seat component part and the second seat component part.

13. The method according to claim 12, wherein one or a plurality of fluid-fillable bladders (51, 52) is arranged on the first and/or the second seat component part or is arranged before assembly or is inserted between the two seat component parts during assembly.
